(19) United States
(12) Patent Application Publication
(10) Pub. No.: US 2015/0230068 A1
(43) Pub. Date: Aug. 13, 2015

(54) METHOD, DEVICE, AND SYSTEM FOR IMPLEMENTING INSTANT REMINDING

(71) Applicant: TENCENT TECHNOLOGY (SHENZHEN) COMPANY LIMITED, Shenzhen (CN)

(72) Inventor: Lieqiang LI, Shenzhen (CN)

(21) Appl. No.: 14/694,229

(22) Filed: Apr. 23, 2015

Related U.S. Application Data
(63) Continuation of application No. PCT/CN2013/082126, filed on Aug. 23, 2013.

(30) Foreign Application Priority Data
Oct. 26, 2012 (CN) 201210417253.X

(51) Int. Cl. H04W 4/12

(52) U.S. Cl. CPC H04W 4/12

(57) ABSTRACT

A method for implementing instant reminding is disclosed, including: generating, by a first terminal, a movement control instruction when detecting that the first terminal moves in a preset manner, and sending the movement control instruction to a second terminal; and receiving, by the second terminal, the movement control instruction, and executing a movement manner corresponding to the movement control instruction according to the movement control instruction, to remind a user that uses the second terminal.

### RELATED APPLICATION

This application is a continuation of International Application No. PCT/CN2013/082126, filed on Aug. 23, 2013. This application claims the benefit and priority of Chinese Patent Application No. CN 201210417253.X, filed with the Chinese Patent Office on Oct. 26, 2012 and entitled “METHOD, DEVICE, AND SYSTEM FOR IMPLEMENTING INSTANT REMINDING”. The disclosures of each of the above applications are incorporated herein by reference in their entireties.

### FIELD OF THE TECHNOLOGY

The present application relates to the field of terminal technologies, and in particular, to a method, device, and system for implementing instant reminding.

### BACKGROUND OF THE DISCLOSURE

With constant development of mobile communications technologies, more people choose to communicate instantly and effectively by using mobile terminals, and meanwhile, various instant messaging tools are also becoming mature. If one party in communication does not send any information in a long time, the other party will choose to enable a reminder function by using a physical key or a virtual function key preset in an instant messaging tool. However, in severe conditions, for example, when light is weak, or a user is on a bumpy road, it is very difficult for the user to quickly and conveniently find the physical key or the virtual function key for enabling the reminder function, and consequently, instant messaging between users cannot be recovered, which significantly affects continuity of the instant messaging.

### SUMMARY

Embodiments of the present application provide a method, device, and system for implementing instant reminding, so that a user can conveniently and quickly enable a reminder function by shaking and moving a terminal.

To achieve the foregoing objectives, the embodiments of the present application use the following technical solutions:

A method for implementing instant reminding includes:

receiving a movement control instruction sent by a first terminal, the movement control instruction being generated and sent by the first terminal when detecting that the first terminal moves in a preset manner; and

executing, by the second terminal, a movement manner corresponding to the movement control instruction according to the movement control instruction, to remind a user that uses the second terminal.

A device for implementing instant reminding includes a memory and a processor that communicates with the memory, the memory being configured to store the following instructions that can be executed by the processor:

a generating instruction, configured to generate a movement control instruction when detecting that a first terminal moves in a preset manner; and a sending instruction, configured to instruct the first terminal to send, to a second terminal, the movement control instruction generated according to the generating instruction, so that the second terminal executes a movement manner corresponding to the movement control instruction according to the movement control instruction, to remind a user that uses the second terminal.

A device for implementing instant reminding includes a memory and a processor that communicates with the memory, the memory being configured to store the following instructions that can be executed by the processor:

a receiving instruction, configured to instruct a second terminal to receive a movement control instruction sent by a first terminal, the movement control instruction being generated and sent by the first terminal when detecting that the first terminal moves in a preset manner; and

an executing instruction, configured to instruct the second terminal to execute a movement manner corresponding to the movement control instruction according to the movement control instruction, to remind a user that uses the second terminal.

In the method, device, and system for implementing instant reminding that are provided by embodiments of the present application, in a process in which a user performs instant messaging with another user by using an instant messaging tool, a mobile terminal sends reminder information to another user when detecting that the user shakes the mobile terminal in a preset manner. As compared with a method of triggering reminder information by using a key in the existing technology, in the embodiments, the user can quickly and conveniently enable a reminder function by shaking a mobile phone.

### BRIEF DESCRIPTION OF THE DRAWINGS

To describe the technical solutions of the embodiments of the present application more clearly, the following briefly introduces the accompanying drawings required for describing the embodiments. Apparently, the accompanying drawings in the following description show only some embodiments of the present application, and a person of ordinary skill in the art may still derive other drawings from these accompanying drawings without creative efforts.

FIG. 1 is a composition block diagram of a system for implementing instant reminding according to an embodiment of the present application;

FIG. 2 is a flowchart of a method for implementing instant reminding according to an embodiment of the present application;

FIG. 3 is a flowchart of another method for implementing instant reminding according to an embodiment of the present application;

FIG. 4 is a flowchart of another method for implementing instant reminding according to an embodiment of the present application;

FIG. 5 is an interaction diagram of a method for implementing instant reminding according to an embodiment of the present application;

FIG. 6 is a flowchart of another method for implementing instant reminding according to an embodiment of the present application;

FIG. 7 is a flowchart of another method for implementing instant reminding according to an embodiment of the present application;

FIG. 8 is a composition block diagram of a device for implementing instant reminding according to an embodiment of the present application;

FIG. 9 is a schematic structural diagram of a generating unit 51 in the device for implementing instant reminding shown in FIG. 8;

FIG. 10 is a schematic structural diagram of another device for implementing instant reminding according to an embodiment of the present application;

FIG. 11 is a schematic structural diagram of another device for implementing instant reminding according to an embodiment of the present application;

FIG. 12 is a schematic structural diagram of an executing unit 62 in the device for implementing instant reminding shown in FIG. 11;

FIG. 13 is a schematic structural diagram of another device for implementing instant reminding according to an embodiment of the present application; and

FIG. 14 is a schematic structural diagram of another device for implementing instant reminding according to an embodiment of the present application.

### DESCRIPTION OF EMBODIMENTS

The following clearly and completely describes the technical solutions in the embodiments of the present application with reference to the accompanying drawings in the embodiments of the present application. Apparently, the described embodiments are some of the embodiments of the present application rather than all of the embodiments. All other embodiments obtained by a person of ordinary skill in the art based on the embodiments of the present application without creative efforts shall fall within the protection scope of the present application.

An embodiment of the present application provides a system for implementing instant reminding, which generally may include at least two terminals, where one terminal may be a device having acceleration sensing hardware, such as a mobile phone or a tablet computer, and another terminal may be any device on which an instant messaging tool can run. Setting of this system is intended to help a user implement instant reminding by shaking and moving a terminal when the user communicates with another person by using an instant messaging tool.

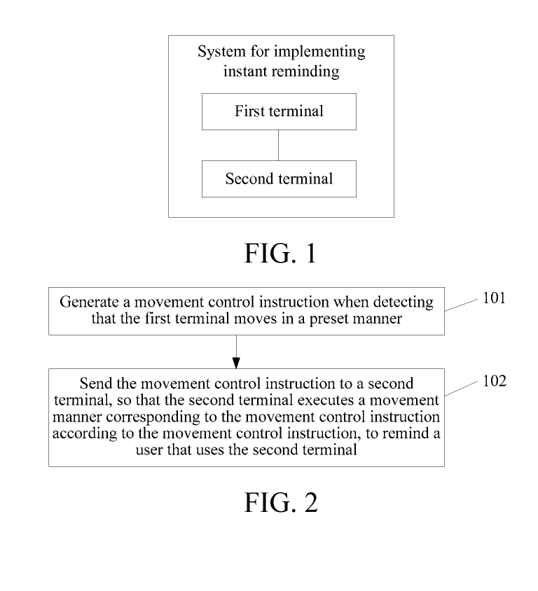

An embodiment of the present application provides a possible implementation manner of a system for implementing instant reminding. As shown in FIG. 1, the system for implementing instant reminding includes a first terminal and a second terminal Based on the foregoing system for implementing instant reminding, a method for implementing instant reminding provided by the present application is described in detail separately from a side of the first terminal and a side of the second terminal.

A process of the method shown in FIG. 2 is a method process on the side of the first terminal, and specifically includes:

101: Generate a movement control instruction when detecting that the first terminal moves in a preset manner.

The generating a movement control instruction may be implemented in the following two methods, specifically:

the first method: determining a movement control instruction corresponding to a current movement manner of the first terminal according to a mapping table; and

the second method: obtaining a movement characteristic parameter of a current movement manner of the first terminal; and generating the movement control instruction according to the movement characteristic parameter.

In the first method, the mapping table is set in advance, and it may be set by a developer or set by a user of the terminal. The mapping table is used to represent a correspondence between preset manners and movement control instructions, and when the user moves the terminal move in a preset manner, the terminal may query a corresponding movement instruction according to the mapping table.

For example, specific content of the mapping table may include: 1, when the user shakes the mobile phone from side to side, send an instruction for controlling a second terminal device to vibrate; 2, when the user shakes the mobile phone up and down, send an instruction for controlling an instant messaging window displayed on the second terminal device to shake, where certainly, this is only an example, which is not limited by the present application; and 3, determine a device type of the second terminal when the user shakes the mobile phone, and send an instruction for controlling the second terminal device to vibrate when the second terminal is a mobile terminal; or send an instruction for controlling an instant messaging window displayed on the second terminal device to shake when the second terminal is a fixed terminal.

In the second method, the movement characteristic parameter may include but is not limited to a shaking frequency of the first terminal and/or a movement duration of the first terminal.

An implementation method for generating the movement control instruction according to the movement characteristic parameter specifically includes: adding, according to a preset movement control instruction format, the movement characteristic parameter to the movement control instruction. In this embodiment, the movement control instruction generated by using the second method does not merely inform the second terminal of a reminding manner; instead, the second terminal needs to determine a corresponding movement manner according to the movement characteristic parameter carried in the movement control instruction.

It is further noteworthy that, in the foregoing two methods, the preset manners both refer to manners in which the user operates the terminal, for example, shaking the terminal from side to side, shaking the terminal up and down, and flipping the terminal such as the mobile phone; and these manners may be determined by combining hardware support of a gravity sensor and an acceleration sensor in the terminal and software support in the terminal Certainly, further, the preset manner may also be set to a unique definite operation manner such as shaking the terminal from side to side twice, shaking the terminal up and down thrice, or flipping the mobile phone once, which is not limited by this embodiment of the present application.

102: Send the movement control instruction to a second terminal, so that the second terminal executes a movement manner corresponding to the movement control instruction according to the movement control instruction, to remind a user that uses the second terminal.

The movement control instruction may be directly transmitted by using a network connection between the first terminal and the second terminal, without setting a new communications manner.

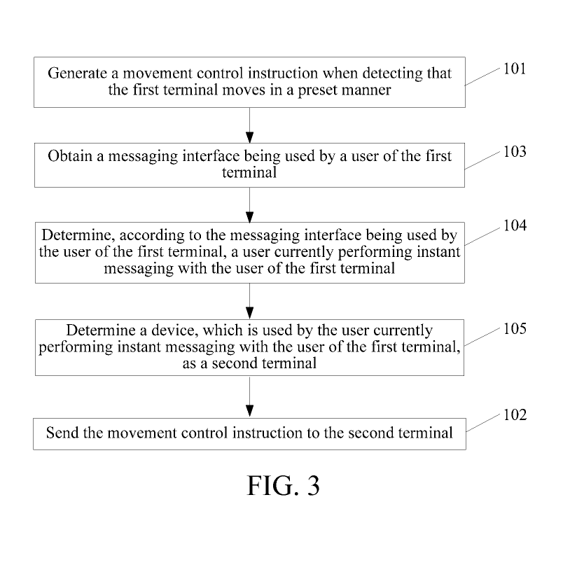

Further, when a user of the first terminal is using the first terminal to communicate with multiple contacts by using the instant messaging tool, it needs to determine which contact the user of the first terminal is sending a reminder to. Therefore, before step 102, as shown in FIG. 3, the method further includes:

103: Obtain a messaging interface being used by a user of the first terminal.

The messaging interface is provided by the instant messaging tool of the first terminal.

104: Determine, according to the messaging interface being used by the user of the first terminal, a user currently performing instant messaging with the user of the first terminal.

105: Determine a device, which is used by the user currently performing instant messaging with the user of the first terminal, as the second terminal.

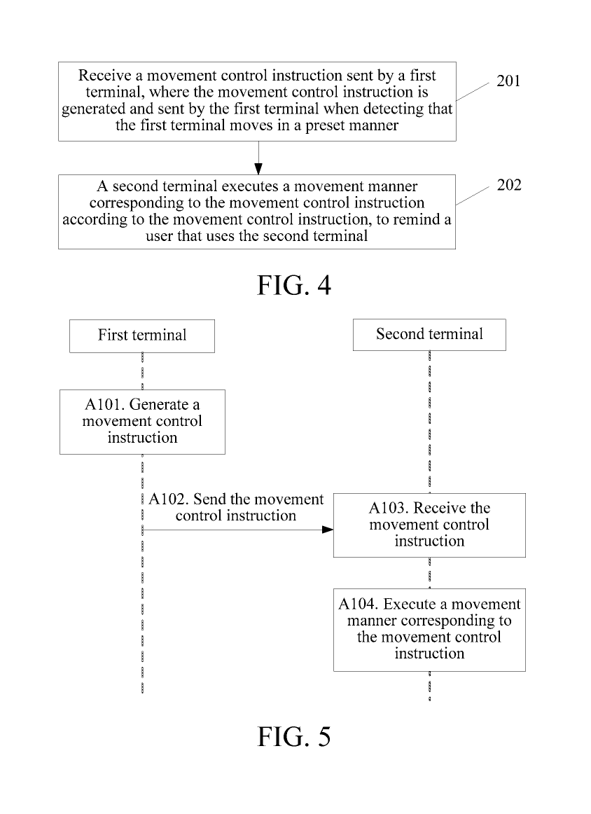

A process of the method shown in FIG. 4 is a method process on the side of the second terminal, and specifically includes:

201: Receive a movement control instruction sent by a first terminal, where the movement control instruction is generated and sent by the first terminal when detecting that the first terminal moves in a preset manner.

202: A second terminal executes a movement manner corresponding to the movement control instruction according to the movement control instruction, to remind a user that uses the second terminal.

The executing a movement manner corresponding to the movement control instruction according to the movement control instruction may be implemented in the following two methods, specifically:

the first method: determining, according to a mapping table, a movement manner corresponding to the movement control instruction sent by the first terminal, and executing the movement manner corresponding to the movement control instruction sent by the first terminal; and

the second method: obtaining a movement characteristic parameter carried in the movement control instruction; and determining a movement manner corresponding to the movement characteristic parameter according to the movement characteristic parameter, and executing the movement manner corresponding to the movement characteristic parameter.

In the first method, setting of the mapping table is the same as setting of the mapping table on the side of the first terminal.

In the second method, a specific implementation of determining a movement manner corresponding to the movement characteristic parameter according to the movement characteristic parameter may include: 1, the second terminal vibrates for a duration equal to a movement duration of the first terminal; 2, the second terminal intermittently triggers device vibration according to a shaking frequency of the first terminal; 3, the second terminal controls the displayed messaging interface to shake for a duration equal to the movement duration of the first terminal; and 4, the second terminal intermittently controls, according to the shaking frequency of the first terminal, the displayed messaging interface to shake.

This embodiment of the present application provides a method for implementing instant reminding. In a process in which a user performs instant messaging with another user by using an instant messaging tool, a terminal, for example, a device such as a mobile phone or a tablet computer having acceleration sensing hardware, sends movement control signaling to the another user when detecting that the user shakes the mobile terminal in a preset manner. As compared with a method of triggering the reminder information by using a key in the existing technology, in this embodiment, the user can quickly and conveniently enable a reminder function by shaking the terminal, which improves operability and experience for the user.

Further, with reference to the foregoing methods on the side of the first terminal and the side of the second terminal, in the system for implementing instant reminding shown in FIG. 1, this embodiment of the present application herein describes a specific interaction process between the first terminal and the second terminal, and as shown in FIG. 5, the process includes:

A101: The first terminal generates a movement control instruction when detecting that the first terminal moves in a preset manner.

A102: The first terminal sends the movement control instruction to the second terminal.

A103: The second terminal receives the movement control instruction.

A104: The second terminal executes a movement manner corresponding to the movement control instruction according to the movement control instruction, to remind a user that uses the second terminal.

In a first possible implementation manner of A101 to A104 in the foregoing interaction process, in step A101 and step A103, if a specific implementation method of step A101 is determining a movement control instruction corresponding to a current movement manner of the first terminal according to a mapping table, a specific implementation method of step A103 is determining, according to the mapping table, a movement manner corresponding to the movement control instruction sent by the first terminal, and executing the movement manner corresponding to the movement control instruction sent by the first terminal.

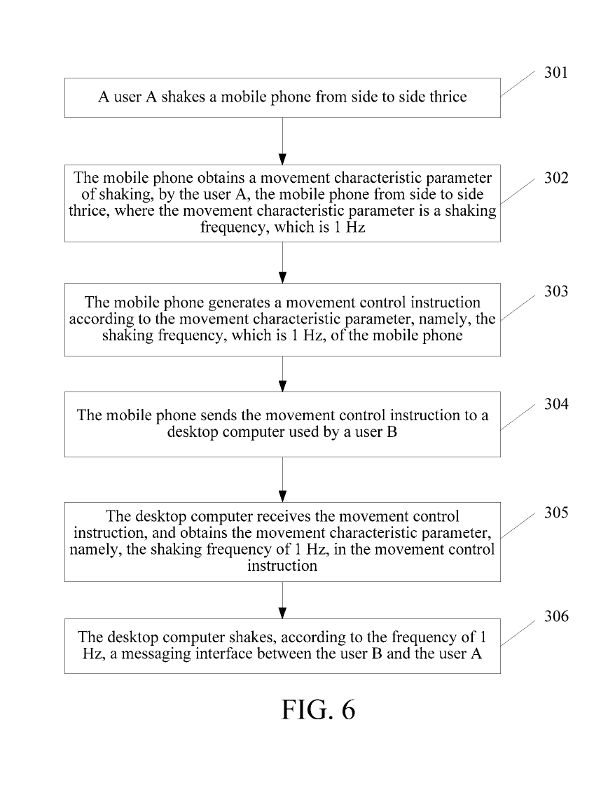

Further, the first possible implementation manner provided by this embodiment of the present application may be applied to the following actual scenario, where the scenario includes: a user A using a mobile phone is performing instant messaging with a user B using a desktop computer, and when the user B does not respond in a long time, the user A reminds the user B by using the following process. As shown in FIG. 6, the process includes:

301: The user A shakes the mobile phone from side to side thrice.

302: The mobile phone obtains a movement characteristic parameter of shaking, by the user A, the mobile phone from side to side thrice, where the movement characteristic parameter is a shaking frequency, which is 1 Hz.

303: The mobile phone generates a movement control instruction according to the movement characteristic parameter, namely, the shaking frequency, which is 1 Hz, of the mobile phone.

304: The mobile phone sends the movement control instruction to the desktop computer used by the user B.

305: The desktop computer receives the movement control instruction, and obtains the movement characteristic parameter, namely, the shaking frequency of 1 Hz, in the movement control instruction.

306: The desktop computer shakes, according to the frequency of 1 Hz, a messaging interface between the user B and the user A.

In a second possible case of A101 to A104 in the foregoing interaction process, in step A101 and step A103, if a specific implementation method of step A101 is obtaining a movement characteristic parameter of a current movement manner of the first terminal; and generating the movement control instruction according to the movement characteristic parameter, a specific implementation method of step A103 is obtaining a movement characteristic parameter carried in the movement control instruction; and determining a movement manner corresponding to the movement characteristic parameter according to the movement characteristic parameter, and executing the movement manner corresponding to the movement characteristic parameter.

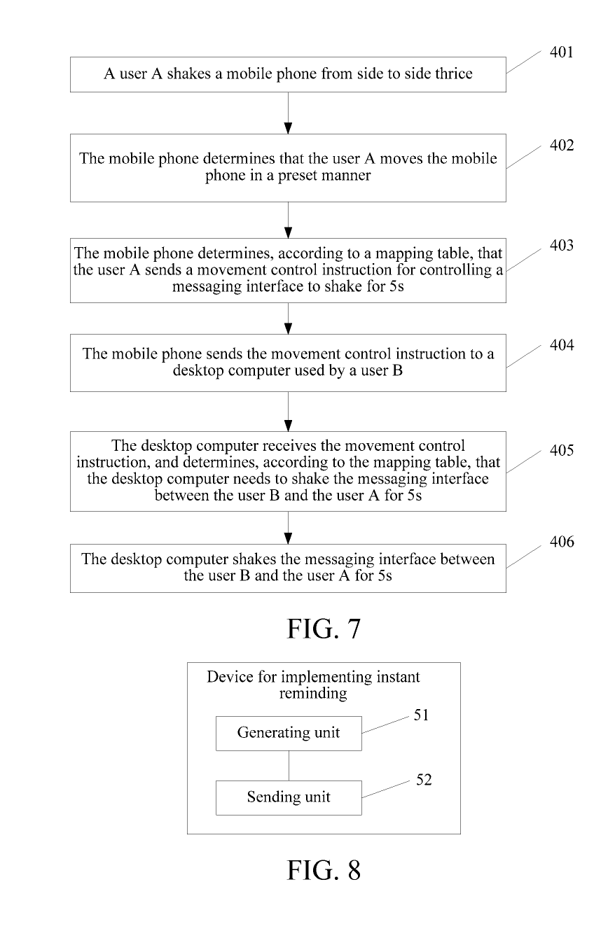

Further, the second possible implementation manner provided by this embodiment of the present application may be applied to the following actual scenario, where the scenario includes: a user A using a mobile phone is performing instant messaging with a user B using a desktop computer, and when the user B does not respond in a long time, the user A reminds the user B by using the following process. As shown in FIG. 7, the process includes:

401: The user A shakes the mobile phone from side to side thrice.

402: The mobile phone determines that the user A moves the mobile phone in a preset manner.

403: The mobile phone determines, according to a mapping table, that the user A sends a movement control instruction for controlling a messaging interface to shake for 5s.

404: The mobile phone sends the movement control instruction to the desktop computer used by the user B.

405: The desktop computer receives the movement control instruction, and determines, according to the mapping table, that the desktop computer needs to shake the messaging interface between the user B and the user A for 5s.

406: The desktop computer shakes the messaging interface between the user B and the user A for 5s.

In addition, in both the first possible implementation manner and the second possible implementation manner described above, before sending the movement control instruction to the second terminal, the first terminal may perform the following steps, including:

obtaining, by the first terminal, a messaging interface being used by a user of the first terminal; determining, according to the messaging interface being used by the user of the first terminal, a user currently performing instant messaging with the user of the first terminal; and determining a device, which is used by the user currently performing instant messaging with the user of the first terminal, as the second terminal.

This embodiment of the present application provides a method for implementing instant reminding. In a process in which a user performs instant messaging with another user by using an instant messaging tool, a terminal, for example, a device such as a mobile phone or a tablet computer having acceleration sensing hardware, sends movement control signaling to the another user when detecting that the user shakes the mobile terminal in a preset manner. As compared with a method of triggering the reminder information by using a key in the existing technology, in this embodiment, the user can quickly and conveniently enable a reminder function by shaking the terminal, which improves operability for the user.

An embodiment of the present application further provides a device for implementing instant reminding. As shown in FIG. 8, the device includes: a generating unit 51 and a sending unit 52. The device shown in FIG. 8 may be an implementation manner of the first terminal in the system for implementing instant reminding shown in FIG. 1.

The generating unit 51 is configured to generate a movement control instruction when detecting that the first terminal moves in a preset manner.

The sending unit 52 is configured to send the movement control instruction generated by the generating unit 51 to a second terminal, so that the second terminal executes a movement manner corresponding to the movement control instruction according to the movement control instruction, to remind a user that uses the second terminal.

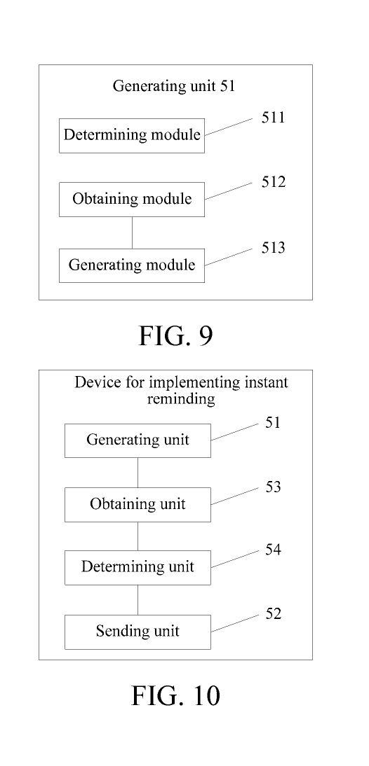

Optionally, as shown in FIG. 9, the generating unit 51 in the device for implementing instant reminding shown in FIG. 8 may further include: a determining module 511, an obtaining module 512, and a generating module 513.

The determining module 511 is configured to determine a movement control instruction corresponding to a current movement manner of the first terminal according to a mapping table.

The obtaining module 512 is configured to obtain a movement characteristic parameter of a current movement manner of the first terminal.

The generating module 513 is configured to generate the movement control instruction according to the movement characteristic parameter obtained by the obtaining module 512.

The generating unit 51 in the device for implementing instant reminding shown in FIG. 8 may only include the foregoing determining module 511 (which is not shown in the figure), or only include the foregoing obtaining module 512 and generating module 513 (which are not shown in the figure).

Optionally, the movement characteristic parameter includes a shaking frequency of the first terminal and/or a movement duration of the first terminal.

FIG. 10 is a schematic structural diagram of another device for implementing instant reminding according to an embodiment of the present application. As shown in FIG. 10, the device includes a generating unit 51, a sending unit 52, an obtaining unit 53, and a determining unit 54.

Functions of the generating unit 51 and the sending unit 52 are shown in FIG. 8, and details are not described herein again. The obtaining unit 53 is configured to obtain a messaging interface being used by a user of the first terminal.

The determining unit 54 is configured to determine, according to the messaging interface being used by the user of the first terminal and is obtained by the obtaining unit 53, a user currently performing instant messaging with the user of the first terminal; and determine a device, which is used by the user currently performing instant messaging with the user of the first terminal, as a second terminal.

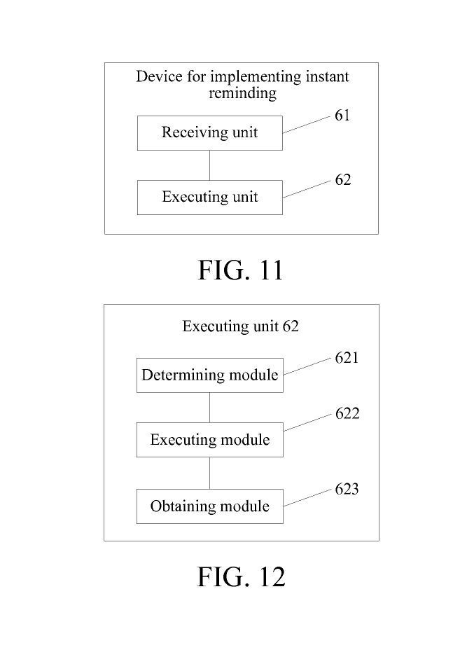

An embodiment of the present application further provides a device for implementing instant reminding. As shown in FIG. 11, the device includes: a receiving unit 61 and an executing unit 62. The device shown may be an implementation manner of the second terminal in the system for implementing instant reminding shown in FIG. 1.

The receiving unit 61 is configured to receive a movement control instruction sent by a first terminal, where the first terminal generates and sends the movement control instruction when detecting that the first terminal moves in a preset manner.

The executing unit 62 is configured to execute a movement manner corresponding to the movement control instruction according to the movement control instruction received by the receiving unit 61, to remind a user that uses the second terminal.

FIG. 12 is a schematic structural diagram of an executing unit 62 in the device for implementing instant reminding shown in FIG. 11. As shown in FIG. 12, the executing unit 62 includes: a determining module 621, an executing module 622, and an obtaining module 623.

The determining instruction 621 is configured to determine, according to a mapping table, a movement manner corresponding to the movement control instruction sent by the first terminal; and configured to determine, according to a movement characteristic parameter obtained by the obtaining module 623, a movement manner corresponding to the movement characteristic parameter.

The executing module 622 is configured to execute the movement manner which is determined by the determining module 621 and corresponding to the movement control instruction sent by the first terminal; or configured to execute the movement manner corresponding to the movement characteristic parameter.

The obtaining module 623 is configured to obtain a movement characteristic parameter carried in the movement control instruction.

The movement characteristic parameter includes a shaking frequency of the first terminal and/or a movement duration of the first terminal.

An embodiment of the present application further provides a machine-readable storage medium, to store an instruction that causes a machine to execute the method for implementing instant reminding described herein. Specifically, a system or an apparatus equipped with a storage medium may be provided, where software program code for implementing the functions in any one of the foregoing embodiments is stored in the storage medium, and a computer (or a CPU or an MPU) of the system or apparatus is made to read and execute the program code stored in the storage medium.

In this case, the program code read from the storage medium can implement the functions in any one of the foregoing embodiments, and therefore the program code and the storage medium for storing the program code constitute a part of the present application.

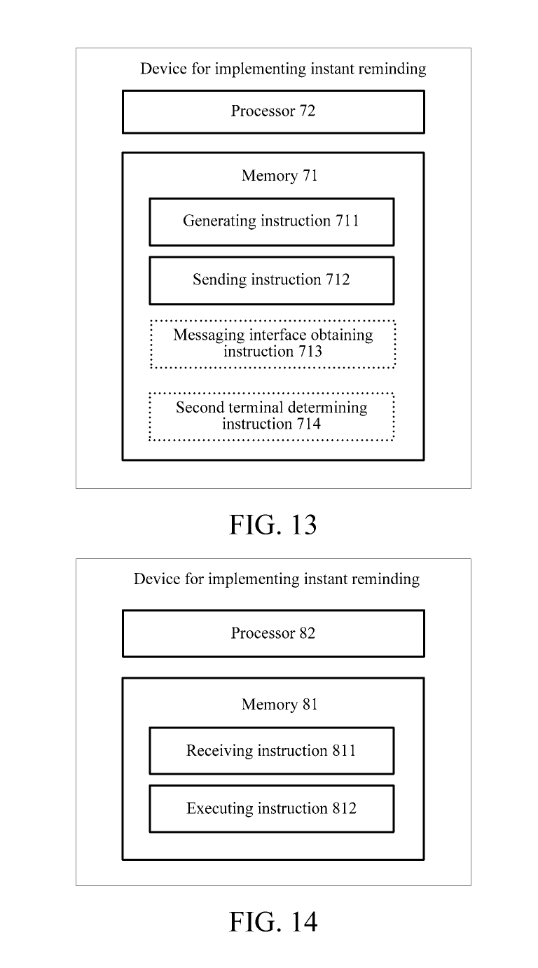

FIG. 13 is a schematic structural diagram of another device for implementing instant reminding according to an embodiment of the present application. The device may be an implementation manner of the first terminal in the system for implementing instant reminding shown in FIG. 1.

As shown in FIG. 13, the device may include a memory 71, and one or multiple processors 72 that communicate with the memory 71. For simplicity, FIG. 13 only shows one processor 72. The memory 71 is configured to store the following instructions that can be executed by the processor 72, including a generating instruction 711 and a sending instruction 712.

The generating instruction 711 is configured to generate a movement control instruction when detecting that the device shown FIG. 13, namely, the first terminal, moves in a preset manner.

The sending instruction 712 is used to instruct the first terminal to send, to a second terminal, the movement control instruction generated according to the generating instruction 711, so that the second terminal executes a movement manner corresponding to the movement control instruction according to the movement control instruction, to remind a user that uses the second terminal.

The generating instruction 711 may further include a determining instruction 7111, an obtaining instruction 7112, and a first generating instruction 7113 (which are not shown in the figure).

The determining instruction 7111 is configured to instruct the device shown in FIG. 13, that is, the first terminal, to determine a movement control instruction corresponding to a current movement manner of the first terminal according to a mapping table.

The obtaining instruction 7112 is configured to instruct the first terminal to obtain a movement characteristic parameter of a current movement manner of the first terminal.

The first generating instruction 7113 is configured to instruct the first terminal to generate the movement control instruction according to the movement characteristic parameter that is obtained according to the obtaining instruction 7112.

The generating instruction 711 may only include the foregoing determining instruction 7111 (which is not shown in the figure), or only include the foregoing obtaining instruction 7112 and first generating instruction 7113 (which are not shown in the figure).

The movement characteristic parameter includes a shaking frequency of the first terminal and/or a movement duration of the first terminal.

The memory 71 may further store the following instructions that can be executed by the processor 72: a messaging interface obtaining instruction 713 and a second terminal determining instruction 714.

The messaging interface obtaining instruction 713 is configured to instruct the first terminal to obtain a messaging interface being used by a user of the first terminal.

The second terminal determining instruction 714 is configured to instruct the first terminal to determine, according to the messaging interface being used by the user of the first terminal obtained according to the messaging interface obtaining instruction 713, a user currently performing instant messaging with the user of the first terminal, and determine a device, which is used by the user currently performing instant messaging with the user of the first terminal, as the second terminal.

FIG. 14 is a schematic structural diagram of another device for implementing instant reminding according to an embodiment of the present application. The device may be an implementation manner of the second terminal in the system for implementing instant reminding shown in FIG. 1.

As shown in FIG. 14, the device for implementing instant reminding may include a memory 81, and one or multiple processors 82 that communicate with the memory 81. For simplicity, FIG. 14 only shows one processor 82. The memory 81 is configured to store the following instructions that can be executed by the processor 82, including a receiving instruction 811 and an executing instruction 812.

The receiving instruction 811 is configured to instruct the second terminal to receive a movement control instruction sent by a first terminal, where the first terminal generates and obtains the movement control instruction when detecting that the first terminal moves in a preset manner.

The executing instruction 812 is configured to instruct the second terminal to execute a movement manner corresponding to the movement control instruction according to the movement control instruction that is received according to the receiving instruction 811, to remind a user that uses the second terminal.

The executing instruction 812 may further include: a determining instruction 8121, a first executing instruction 8122, and an obtaining instruction 8123 (which are not shown in the figure).

The determining instruction 8121 is configured to instruct the second terminal to determine, according to a mapping table, a movement manner corresponding to the movement control instruction sent by the first terminal; or configured to instruct the second terminal to determine, according to a movement characteristic parameter that is obtained according to the obtaining instruction 8123, a movement manner corresponding to the movement characteristic parameter.

The first executing instruction 8122 is configured to instruct the second terminal to execute the movement manner which is determined according to the determining instruction 8121 and corresponding to the movement control instruction sent by the first terminal; or configured to instruct the second terminal to execute the movement manner corresponding to the movement characteristic parameter.

The obtaining instruction 8123 is configured to instruct the second terminal to obtain a movement characteristic parameter carried in the movement control instruction.

The movement characteristic parameter includes a shaking frequency of the first terminal and/or a movement duration of the first terminal.

This embodiment of the present application provides a device for implementing instant reminding. In a process in which a user performs instant messaging with another user by using an instant messaging tool, a terminal, for example, a device such as a mobile phone or a tablet computer having acceleration sensing hardware, sends movement control signaling to the another user when detecting that the user shakes the mobile terminal in a preset manner. As compared with a method of triggering the reminder information by using a key in the existing technology, in this embodiment, the user can quickly and conveniently enable a reminder function by shaking the terminal, which improves operability and experience for the user.

What is claimed is:

1. A method for implementing instant reminding, comprising:
receiving a movement control instruction sent by a first terminal, the movement control instruction being generated and sent by the first terminal when detecting that the first terminal moves in a preset manner; and
executing, by a second terminal, a movement manner corresponding to the movement control instruction according to the movement control instruction, to remind a user that uses the second terminal.

2. The method according to claim 1, wherein the executing, by the second terminal, a movement manner corresponding to the movement control instruction according to the movement control instruction comprises:
determining, by the second terminal according to a mapping table, a movement manner corresponding to the movement control instruction sent by the first terminal, and executing the movement manner corresponding to the movement control instruction sent by the first terminal; and/or
obtaining, by the second terminal, a movement characteristic parameter carried in the movement control instruction; and determining a movement manner corresponding to the movement characteristic parameter according to the movement characteristic parameter, and executing the movement manner corresponding to the movement characteristic parameter.

3. The method according to claim 2, wherein the movement characteristic parameter comprises a shaking frequency of the first terminal and/or a movement duration of the first terminal.

4. A device for implementing instant reminding, comprising a memory and a processor that communicates with the memory, the memory being configured to store the following instructions that can be executed by the processor:
a generating instruction, configured to generate a movement control instruction when detecting that a first terminal moves in a preset manner; and
a sending instruction, configured to instruct the first terminal to send, to a second terminal, the movement control instruction generated according to the generating instruction, so that the second terminal executes a movement manner corresponding to the movement control instruction according to the movement control instruction, to remind a user that uses the second terminal.

5. The device according to claim 4, wherein the generating instruction further comprises:
a determining instruction, configured to instruct the first terminal to determine a movement control instruction corresponding to a current movement manner of the first terminal according to a mapping table;
an obtaining instruction, configured to instruct the first terminal to obtain a movement characteristic parameter of the current movement manner of the first terminal; and
a first generating instruction, configured to instruct the first terminal to generate the movement control instruction according to the movement characteristic parameter that is obtained according to the obtaining instruction.

6. The device according to claim 5, wherein the movement characteristic parameter comprises a shaking frequency of the first terminal and/or a movement duration of the first terminal.

7. The device according to claim 4, wherein the memory is further configured to store the following instructions:
a messaging interface obtaining instruction, configured to instruct the first terminal to obtain a messaging interface being used by a user of the first terminal; and
a second terminal determining instruction, configured to instruct the first terminal to determine, according to the messaging interface being used by the user of the first terminal obtained according to the messaging interface obtaining instruction, a user currently performing instant messaging with the user of the first terminal; and determine a device, which is used by the user currently performing instant messaging with the user of the first terminal, as the second terminal.

8. A device for implementing instant reminding, comprising a memory and a processor that communicates with the memory, the memory being configured to store the following instructions that can be executed by the processor:
a receiving instruction, configured to instruct a second terminal to receive a movement control instruction sent by a first terminal, the movement control instruction being generated and sent by the first terminal when detecting that the first terminal moves in a preset manner; and
an executing instruction, used to instruct the second terminal to execute a movement manner corresponding to the movement control instruction according to the movement control instruction that is received according to the receiving instruction, to remind a user that uses the second terminal.

9. The device according to claim 8, wherein the executing instruction comprises:
a determining instruction, configured to instruct the second terminal to determine, according to a mapping table, a movement manner corresponding to the movement control instruction sent by the first terminal; or configured to instruct the second terminal to determine, according to a movement characteristic parameter that is obtained according to an obtaining instruction, a movement manner corresponding to the movement characteristic parameter;
a first executing instruction, configured to instruct the second terminal to execute the movement manner which is determined according to the determining instruction and corresponding to the movement control instruction sent by the first terminal; or configured to instruct the second terminal to execute the movement manner corresponding to the movement characteristic parameter; and
the obtaining instruction, configured to instruct the second terminal to obtain a movement characteristic parameter carried in the movement control instruction.

10. The device according to claim 9, wherein the movement characteristic parameter comprises a shaking frequency of the first terminal and/or a movement duration of the first terminal.
